(19) United States
(12) Patent Application Publication
(10) Pub. No.: US 2026/0159175 A1
(43) Pub. Date: Jun. 11, 2026

(54) Automated Guided Vehicle Comprising Suspended Carrier

(71) Applicant: ABB Schweiz AG, Baden (CH)

(72) Inventor: Jonas Larsson, Västerås (SE)

(73) Assignee: ABB Schweiz AG, Baden (CH)

(21) Appl. No.: 19/537,821

(22) Filed: Feb. 12, 2026

Related U.S. Application Data
(63) Continuation of application No. PCT/EP2023/072907, filed on Aug. 21, 2023.

(51) Int. Cl. B62D 24/04

(52) U.S. Cl. CPC B62D 24/04

(57) ABSTRACT

An automated guided vehicle (AGV) comprising a chassis, a plurality of wheel units connected to the chassis, each wheel unit comprising a wheel for supporting the chassis on a horizontal surface; an electronic control system in signal communication with the wheel units; and one or more resilient suspension elements. The AGV further comprises a suspended carrier suspended from the chassis via the one or more suspension elements. The suspended carrier carries the control system horizontally inside of the chassis and extends horizontally outside of the chassis.

### CROSS-REFERENCE TO RELATED APPLICATIONS

The instant application claims priority to International Patent Application No. PCT/EP2023/072907, filed Aug. 21, 2023, which is incorporated herein in its entirety by reference.

### FIELD OF THE DISCLOSURE

The present disclosure generally relates to automated guided vehicles (AGVs) and, more particularly, to an AGV comprising a suspended carrier.

### BACKGROUND OF THE INVENTION

Automated guided vehicles, AGVs, are typically self-powered, self-driven vehicles. AGVs may be used to transport materials and other items from one location to another, without the need for a driver on the vehicle. An AGV may also comprise a manipulator for performing various tasks. AGVs are commonly used in manufacturing sites, warehouses, post offices, libraries, port terminals, airports, and some hazardous locations and specialty industries.

Many different types of requirements may be imposed on an AGV. AGVs may for example have to be capable of operating in close proximity to various obstacles, such as equipment and humans. An AGV may for example dock to an external structure to charge, pick up material or perform a manipulation task. As further examples, an AGV may have to pass through door openings and navigate through narrow corridors.

When an AGV operates in open spaces, the AGV may use a safety function causing the AGV to automatically stop upon detection of a nearby obstacle, such as stopping movements of a chassis and/or movements of a manipulator relative to the chassis. However, when the AGV needs to be in close proximity to an obstacle in order to perform an operation, such safety function may have to be muted in order to enable the operation. Even if the AGV may operate at restricted speeds when performing such operation while the safety function is muted, there is a potential risk that humans may be squeezed between the AGV and the obstacle.

Moreover, electric components and other components mounted to a chassis of the AGV are typically subjected to vibrations during movements of the AGV. Relatively high requirements regarding the mechanical designs of such components may be needed in order to meet lifetime and quality expectations of the AGV, leading to an increased cost and an increased complexity of the AGV.

CN 213007998 U discloses an AGV trolley comprising a car body, a plurality of wheels and an anti-collision surrounding structure. The anti-collision surrounding structure comprises an anti-collision plate and springs.

### BRIEF SUMMARY OF THE INVENTION

The present disclosure describes an improved automated guided vehicle, AGV. In one embodiment, providing an AGV comprising a chassis, a suspended carrier suspended from the chassis via resilient suspension elements and extending horizontally outside of the chassis, and an electronic control system carried by the suspended carrier horizontally inside of the chassis, the control system will be protected from vibrations during travel of the AGV and will be protected by the chassis, at the same time as the suspended carrier can function as a bumper for the AGV providing relatively low impact forces on external obstacles.

According to one aspect, there is provided an automated guided vehicle, AGV, comprising a chassis; a plurality of wheel units connected to the chassis, each wheel unit comprising a wheel for supporting the chassis on a horizontal surface; an electronic control system in signal communication with the wheel units; and one or more resilient suspension elements. The AGV further comprises a suspended carrier suspended from the chassis via the one or more suspension elements, the suspended carrier carrying the control system horizontally inside of the chassis and extending horizontally outside of the chassis.

The chassis is arranged structurally between the wheel units and the suspended carrier, and the one or more suspension elements are arranged structurally between the chassis and the suspended carrier. In situations where the suspended carrier does not contact the chassis, any loads from the wheel units may only act on the suspended carrier via the chassis and the one or more suspension elements. Thus, no wheels may be directly connected to the suspended carrier. Since the one or more suspension elements are resilient, vibrations originating from the wheel units will be reduced or eliminated at the suspended carrier. Examples of such vibrations may include vibrations originating from the AGV travelling over a threshold or other irregular surface. The one or more suspension elements enable the control system and other components to be mounted directly to the suspended carrier, such as rigidly fixed thereto. Dedicated anti-vibration solutions for such components can therefore be avoided. As a consequence, a more cost-efficient design of the AGV is enabled.

Furthermore, since the suspended carrier extends horizontally outside of the chassis, the suspended carrier rather than the chassis may contact an obstacle, such as a human. The portion of the suspended carrier extending horizontally outside of the chassis thereby provides a bumper for the AGV. The bumper is thus formed by an integrated part of the design of the AGV, i.e., by the same part that carries the control system, without needing to add a dedicated bumper.

Moreover, since the suspended carrier is suspended from the chassis via the one or more suspension elements, the one or more suspension elements allow the suspended carrier to move horizontally relative to the chassis and the wheels which reduces an apparent impact force between the AGV and the obstacle.

The AGV thus provides several functions in combination, including supporting the control system, protecting the control system by the chassis, providing vibration damping for the control system and providing a safety bumper. The AGV thus contains an advantageous design principle.

### BRIEF DESCRIPTION OF THE SEVERAL VIEWS OF THE DRAWING(S)

FIG. 1 is a perspective view of an automated guided vehicle (AGV) comprising a chassis and a suspended carrier in accordance with the disclosure.

FIG. 2 is a perspective view of the chassis of the AGV of FIG. 1.

FIG. 3 is a perspective view of the suspended carrier of the AGV of FIG. 1.

FIG. 4 is a cross-sectional end view of the AGV in section A-A in FIG. 3.

FIG. 5 is a further cross-sectional end view of the AGV in section A-A in FIG. 3 when the suspended carrier has moved relative to the chassis.

FIG. 6 is a partial top view of the AGV of FIG. 1.

FIG. 7 is a partial top view of an AGV according to a further example in accordance with the disclosure.

FIG. 8 is a side view of an AGV according to a further example in accordance with the disclosure.

### DETAILED DESCRIPTION OF THE INVENTION

In the following, an AGV comprising a suspended carrier, will be described. The same or similar reference numerals will be used to denote the same or similar structural features.

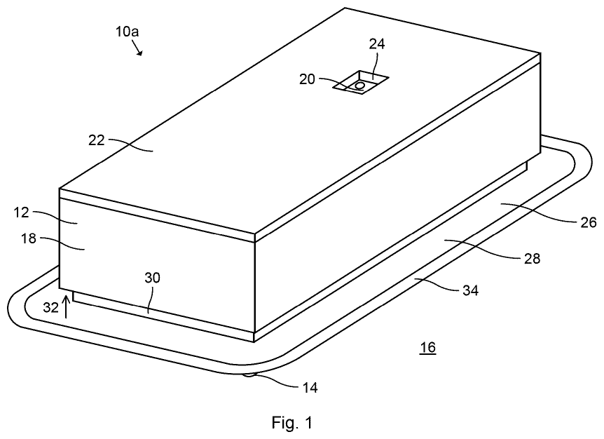

FIG. 1 schematically represents a perspective view of an automated guided vehicle 10a, AGV. The AGV 10a comprises a chassis 12 and a plurality of wheels 14. The AGV 10a of this example comprises four wheels 14 (only one of the wheels 14 is visible in FIG. 1). The wheels 14 support the chassis 12 on a horizontal surface 16, here exemplified as a floor.

The chassis 12 of this example is rectangular. One wheel 14 is positioned at each corner of the rectangular shape of the chassis 12. The chassis 12 of this example comprises a chassis barrier 18. The chassis barrier 18 of this example comprises four vertical walls.

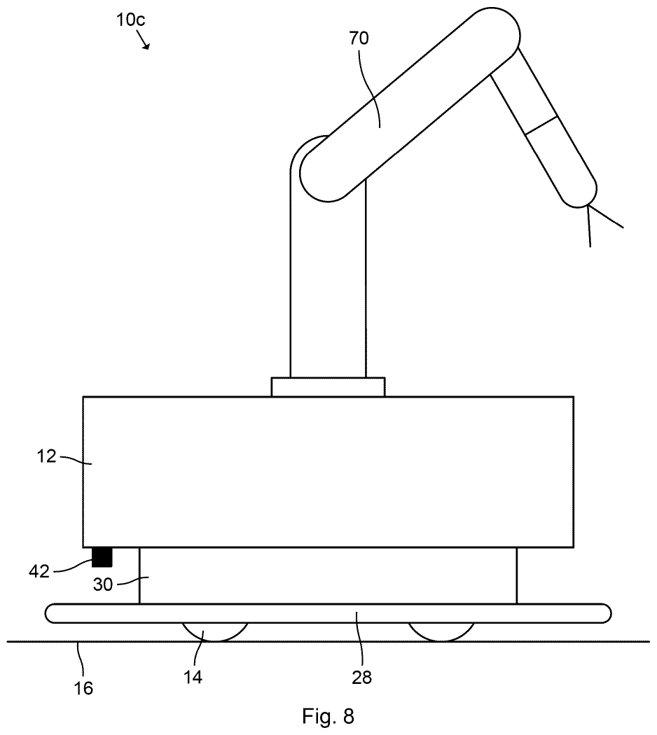

The chassis 12 of this example further comprises a mounting plate 20. A manipulator (FIG. 8) may be connected to the mounting plate 20. The AGV 10a of this example further comprises a cover 22 arranged on top of the chassis 12, e.g., detachably attached thereto by a plurality of fasteners (not shown). The cover 22 of this example is a plate comprising a cover opening 24. The mounting plate 20 can be accessed through the cover opening 24.

The AGV 10a further comprises a suspended carrier 26. The suspended carrier 26 is suspended from the chassis 12. The suspended carrier 26 is allowed to move horizontally relative to the chassis 12. Furthermore, as shown in FIG. 1, the suspended carrier 26 extends horizontally outside of the chassis 12 in all horizontal directions. The portion of the suspended carrier 26 horizontally outside of the chassis 12 therefore provides a bumper for the AGV 10a. Moreover, the suspended carrier 26 horizontally encloses the chassis 12, e.g., as seen vertically from above.

The suspended carrier 26 of this example comprises a suspended platform 28, here exemplified as a plate. The suspended platform 28 is horizontally oriented in FIG. 1. The suspended carrier 26 of this example further comprises a suspended barrier 30. The suspended barrier 30 is fixed to, and extends upwardly from, the suspended platform 28. The suspended barrier 30 of this example comprises four vertical walls.

FIG. 1 further denotes a space 32. The suspended carrier 26 can move horizontally relative to the chassis 12 within the space 32. The space 32 is positioned horizontally inside of the chassis 12 and horizontally between the chassis 12 and the suspended carrier 26. The space 32 is here a channel enclosing the suspended barrier 30. The space 32 is here defined between the suspended barrier 30 and the chassis barrier 18. The suspended carrier 26 of this example further comprises an external damping structure 34. The external damping structure 34 is here exemplified as a rubber list enclosing the suspended platform 28 in a horizontal plane.

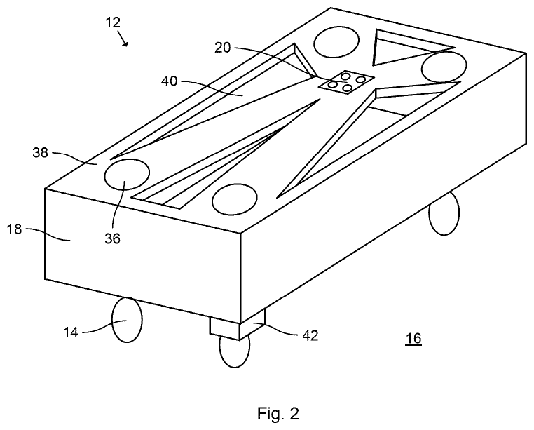

FIG. 2 schematically represents a perspective view of the chassis 12 and a partial perspective view of the AGV 10a. As shown in FIG. 2, the AGV 10a of this example comprises four wheel-units 36. Each wheel unit 36 is connected to the chassis 12 and comprises one of the wheels 14. In this specific example, each wheel unit 36 is configured to drive the respective wheel 14 to rotate about a horizontal wheel axis and to rotate about a vertical steering axis. The chassis 12 of this example further comprises a chassis platform 38. The chassis platform 38 is here exemplified as a plate. The chassis platform 38 is horizontally oriented in FIG. 2. The chassis barrier 18 is fixed to, and extends downwardly from, the chassis platform 38. The chassis platform 38 of this example comprises a plurality of chassis openings 40.

FIG. 2 further shows that the AGV 10a of this example further comprises two topographic sensors 42 (only one is visible in FIG. 2). The topographic sensors 42 are here exemplified as two-dimensional LIDAR sensors arranged to detect a topography of an environment around the AGV 10a in a horizontal plane. As can be gathered from FIG. 2, each topographic sensor 42 of this example is connected to the chassis 12 and is positioned entirely inside of the chassis 12 in a horizontal direction. The topographic sensors 42 are here fixed to the chassis barrier 18.

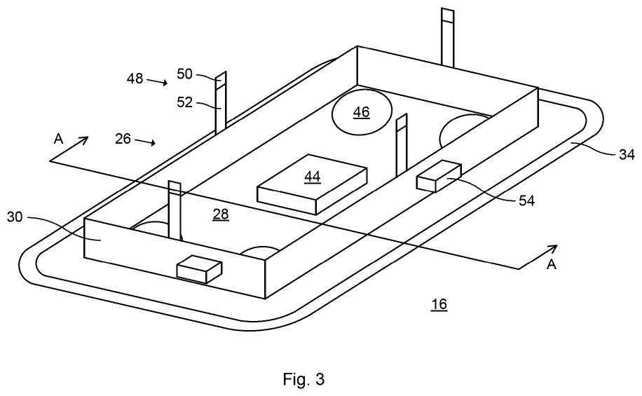

FIG. 3 schematically represents a perspective view of the suspended carrier 26 and a partial perspective view of the AGV 10a. As shown in FIG. 3, the AGV 10a further comprises an electronic control system 44. The control system 44 is carried by the suspended carrier 26. In this example, the control system 44 is mounted to the suspended platform 28 inside of the suspended barrier 30. The control system 44 is thereby positioned horizontally inside of the chassis 12. A volume for accommodation of various components in addition to the control system 44 is provided inside the suspended barrier 30.

The control system 44 is in signal communication with the wheel units 36 and the topographic sensors 42. The control system 44 may for example issue drive signals to the wheel units 36 to cause the AGV 10a to move over the horizontal surface 16. After removal of the cover 22, the control system 44 can be accessed from above through the chassis openings 40 in the chassis 12. The suspended carrier 26 of this example comprises a wheel opening 46 for each wheel 14. In this example, the wheel openings 46 are provided in the suspended platform 28.

FIG. 3 further shows that the AGV 10a of this example comprises a plurality of suspension elements 48, here four suspension elements 48. Each suspension element 48 is connected to the suspended carrier 26 and to the chassis 12. The suspended carrier 26 is thereby suspended from the chassis 12 by the suspension elements 48. Each suspension element 48 is resilient such that the suspended carrier 26 can move horizontally relative to the chassis 12. In this specific example, one suspension element 48 is connected to each wall of the suspended barrier 30, here to an upper end of each wall.

In this example, each suspension element 48 comprises a spring 50 and an elongated member 52. Each spring 50 here provides resiliency for the respective suspension element 48. In this example, each elongated member 52 is arranged between the suspended carrier 26 and a respective springs 50.

The elongated members 52 are here exemplified as rigid bars. Each elongated member 52 may be allowed to rotate slightly relative to the suspended carrier 26 as the suspended carrier 26 is horizontally displaced relative to the chassis 12, e.g. by a respective lower joint between the respective elongated member 52 and the suspended barrier 30 (not shown). Alternatively, each elongated member 52 may be flexible, such as constituted by a rope.

FIG. 3 further shows that the AGV 10a of this example comprises a plurality of displacement sensors 54, here four displacement sensors 54 (only two are visible in FIG. 3). Each displacement sensor 54 is arranged to sense a horizontal displacement of the suspended carrier 26 relative to the chassis 12. Each displacement sensor 54 is in signal communication with the control system 44. In this example, each displacement sensor 54 is fixed to the suspended carrier 26, here to an outside of a respective wall of the suspended barrier 30. The displacement sensors 54 may alternatively be fixed to the chassis 12, such as to an inside of a respective wall of the chassis barrier 18. In any case, each displacement sensor 54 may be positioned in the space 32.

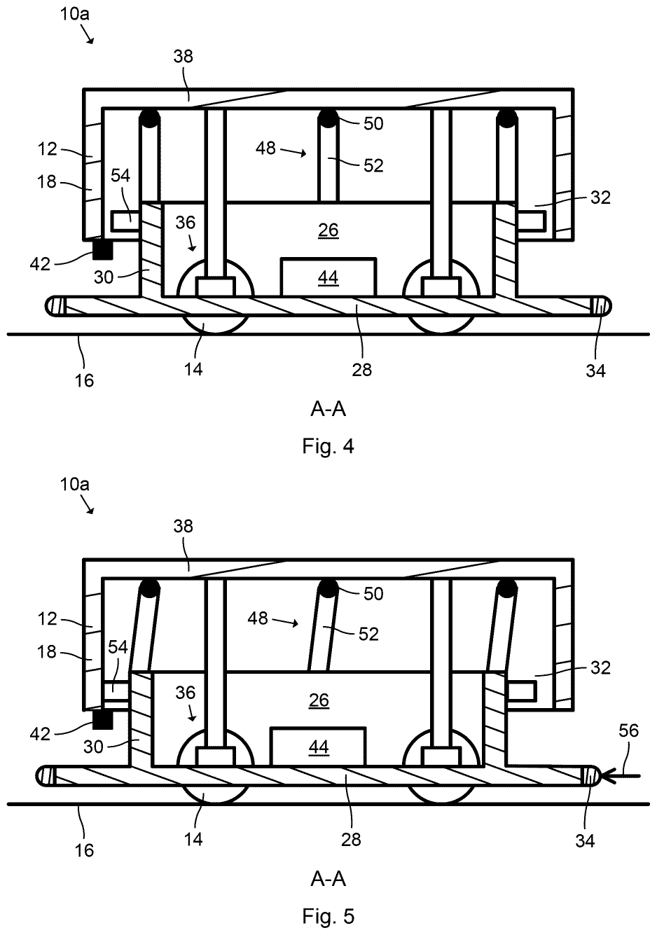

FIG. 4 schematically represents a cross-sectional end view of the AGV 10a in section A-A in FIG. 3. In FIG. 4, is can be seen more clearly that the topographic sensors 42 are positioned horizontally inside of the chassis 12 and that the displacement sensors 54 are positioned in the space 32 in this example. These positionings of the topographic sensor 42 and the displacement sensors 54 enable protection of these sensors and a compact design of the AGV 10a. As can be gathered from FIG. 4, the space 32 encloses all wheel units 36.

FIG. 4 further shows that the suspension elements 48 are connected to the chassis 12. In this example, the respective springs 50 are connected to the chassis platform 38 horizontally inside of the chassis barrier 18. The springs 50 may for example be rubber O-rings. The suspension elements 48 hang from the chassis 12 and the suspended carrier 26 hangs in the suspension elements 48. The suspension elements 48 may thus be referred to as hangers. The entire load of the suspended carrier 26 and of any components thereon is carried by the suspension elements 48. The chassis 12 is thus arranged structurally between the wheel units 36 and the suspended carrier 26, and the suspension elements 48 are thus arranged structurally between the chassis 12 and the suspended carrier 26.

When the AGV 10a travels over the horizontal surface 16, any appearing obstacles may be detected by the topographic sensors 42. If an obstacle is detected, the AGV 10a may perform a safety stop, such as by stopping all wheels 14. This constitutes one example of a safety function. When the topographic sensors 42 are active to provide this safety function, the displacement sensors 54 may be muted, and vice versa.

As the AGV 10a travels over the horizontal surface 16, vibrations may occur in the wheels 14 and in the chassis 12. However, due to the suspension elements 48, vibrations are not transferred, or are only transferred at a substantially lower extent, to the suspended carrier 26. In this way, the control system 44 mounted on the suspended carrier 26 can be protected from vibrations without needing any dedicated damping solution between the suspended carrier 26 and the control system 44. As shown in FIG. 4, the control system 44 is also well protected horizontally inside of the chassis 12. The chassis barrier 18 and the suspended barrier 30 overlap each other and further protect the control system 44.

FIG. 5 schematically represents a further cross-sectional end view of the AGV 10a in section A-A in FIG. 3. In this example, when the AGV 10a has to operate in proximity to an obstacle (not shown) to perform a task, the safety function provided by the topographic sensors 42 is muted and the displacement sensors 54 are activated. When the topographic sensors 42 are muted, the AGV 10a may operate at reduced speed.

When the AGV 10a collides with the obstacle, the obstacle will be contacted by the suspended carrier 26, here the external damping structure 34 thereof. The suspended carrier 26 thus functions as a bumper. A force 56 resulting from this impact and acting on the suspended carrier 26 will cause the suspended carrier 26 to move relative to the chassis 12 in the horizontal direction, as shown in FIG. 5. In this example, the suspended carrier 26 will swing relative to the chassis 12 due to the suspension elements 48 being exemplified as hangers. The springs 50 thus act as joints when the suspended carrier 26 swings relative to the chassis 12. The suspended carrier 26 will thus not move strictly in the horizontal direction in this example. The exact movement direction of the suspended carrier 26 will depend on the lengths of the suspension elements 48, which may for example be at least 50% of a height of the suspended barrier 30.

Since the AGV 10a allows relative movements between the suspended carrier 26 and the chassis 12, the impact on the obstacle will be lower in comparison with if the suspended carrier 26 would be rigidly fixed to the chassis 12. Moreover, the springs 50 and the external damping structure 34 will contribute to reducing this impact.

The horizontal movement of the suspended carrier 26 relative to the chassis 12 will cause one or more of the displacement sensors 54 to detect this movement. Due to the design principle of the suspended carrier 26, the AGV 10a may not need any hardware in addition to the displacement sensor 54 to detect this movement. In FIG. 5, the left displacement sensor 54 is brought into contact with the chassis 12, here with the chassis barrier 18 thereof, due to the horizontal movement of the suspended carrier 26. The displacement sensors 54 may thus for example be contact sensors. The displacement sensor 54 thereby issues a signal indicative of the displacement of the suspended carrier 26 to the control system 44. In response, the control system 44 commands the AGV 10a to stop. The displacement sensors 54 may alternatively be optic sensors arranged to optically detect movements of the suspended carrier 26 relative to the chassis 12.

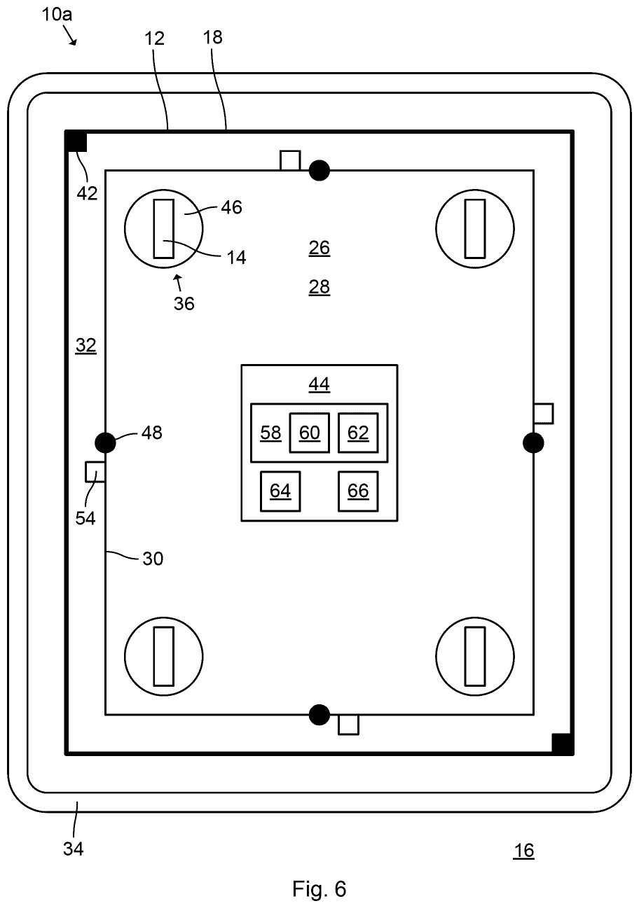

FIG. 6 schematically represents a partial top view of the AGV 10a. In FIG. 6, it is shown that the control system 44 of this example comprises a controller 58. The controller 58 comprises a data processing device 60 and a memory 62. The memory 62 has a computer program stored thereon. The computer program comprises program code which, when executed by the data processing device 60, causes the data processing device 60 to perform, or command performance of, various steps as described herein. As shown in FIG. 6, the control system 44 of this example further comprises an energy storage 64, such as a battery, and a power management unit 66. The energy storage 64 provides power for the wheel units 36. The power management unit 66 is configured to monitor the energy storage 64. Each of the controller 58, the energy storage 64 and the power management unit 66 is here fixed to the suspended carrier 26 without any intermediate dedicated vibration isolation.

FIG. 6 further shows that the wheel units 36 and the suspension elements 48 are alternatingly arranged along a path substantially conforming to an exterior profile of the chassis 12. One suspension element 48 and one displacement sensor 54 are connected to each wall of the suspended barrier 30 in this example.

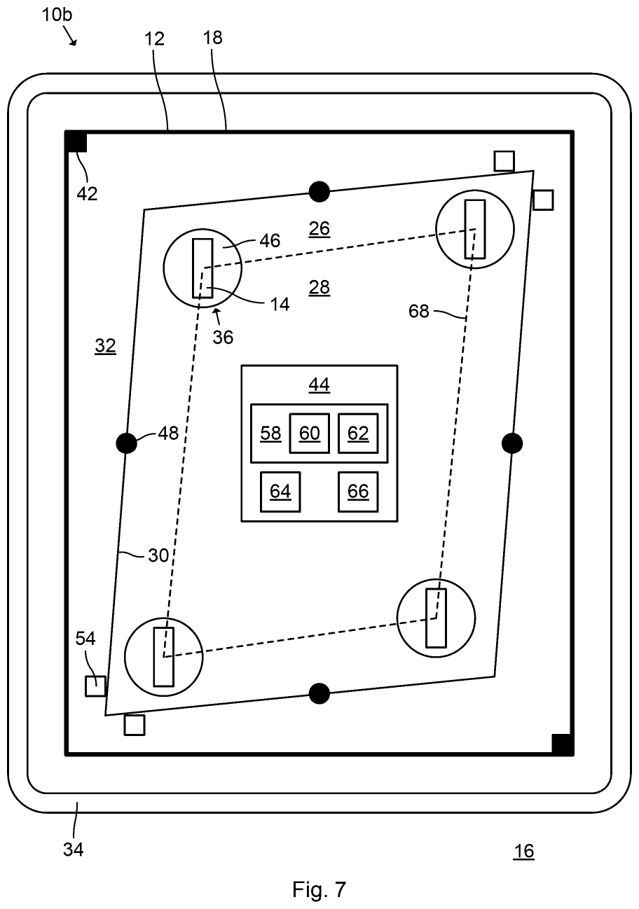

FIG. 7 schematically represents a partial top view of an AGV 10b according to a further example. The AGV 10b differs from the AGV 10a in that in the AGV 10b, the wheel units 36 are arranged at corners of a parallelogram shape 68. Moreover, each topographic sensor 42 is connected to the chassis 12, here at a corner of the chassis barrier 18 most adjacent to a corner of the parallelogram shape 68 having an obtuse angle. As can be gathered from FIG. 7, more space is provided for each topographic sensor 42. Consequently, larger topographic sensors 42 can be used and/or the design of the AGV 10b can be made more compact.

FIG. 8 schematically represents a side view of an AGV 10c according to a further example. The AGV 10c differs from the AGV 10a in that the AGV 10c further comprises a manipulator 70, here exemplified as a robot arm. The manipulator 70 is connected to the mounting plate 20 and is in signal communication with the control system 44. The control system 44 is configured to control the manipulator 70 to perform various tasks including movements of the manipulator 70 relative to the chassis 12, both when the chassis 12 is at standstill and when the chassis 12 moves over the horizontal surface 16.

In the context of the present disclosure, the AGV may further optionally comprise a manipulator. The manipulator may be a robot arm programmable in three or more axes, such as in six or seven axes. The manipulator may be supported on chassis and movable relative to the chassis. When the AGV comprising the manipulator is at standstill, the chassis is in a stationary position but the manipulator may move relative to the chassis. The AGV may for example be an autonomous mobile robot, AMR, or an autonomous mobile manipulator robot, AMMR, comprising the manipulator.

The chassis may be circular or polygonal, such as rectangular. When the chassis is polygonal, each wheel unit may be arranged at a corner of the chassis.

For one, several or all of the wheel units, the wheel unit may be configured to drive the wheel around a wheel axis. When the AGV is positioned on the horizontal surface, each wheel axis may be horizontal.

According to one example, each wheel unit is configured to drive the wheel around the respective wheel axis and around a respective steering axis, transverse to the respective wheel axis. According to a further example, the AGV comprises a differential drive, i.e., two wheel units where each wheel unit is configured to drive the wheel around the wheel axis, but not around a steering axis. In such examples, the two wheels of the wheel units may be oriented in parallel. AGVs comprising a differential drive may or may not comprise further wheel units.

The control system may comprise at least one data processing device and at least one memory having at least one computer program stored thereon, the at least one computer program comprising program code which, when executed by the at least one data processing device, causes the at least one data processing device to perform, or command performance of, various steps as described herein. The control system may for example be configured to control the wheel units and/or to control a manipulator of the AGV. The control system may additionally comprise a power management unit and/or an energy storage, such as a battery.

The one or more suspension elements may carry the entire load of the suspended carrier and any components supported thereon, including the control system. The one or more suspension elements may be resilient such that a horizontal force of 50 N acting on the suspended carrier causes the suspended carrier to move at least 5 mm in a horizontal direction relative to the chassis.

The one or more suspension elements may hang in the chassis. The suspended carrier may in turn hang in the one or more suspension elements. In these cases, the suspended carrier can swing relative to the chassis. Moreover, in these cases, each suspension element may be constituted by a hanger. The one or more suspension element may thus be positioned below the chassis, and the suspended carrier may thus be positioned below the one or more suspension elements. The suspended carrier may also be referred to as a cradle.

The AGV may further comprise a space horizontally inside of the chassis and defined horizontally between the chassis and the suspended carrier.

The space may be a channel enclosing the wheel units.

The chassis may comprise a chassis platform and a chassis barrier extending downwardly from the chassis platform. The suspended carrier may comprise a suspended platform and a suspended barrier extending upwardly from the suspended platform. In these cases, the space may be defined between the chassis barrier and the suspended barrier. If the chassis comprises a chassis platform, the chassis platform may comprise a chassis opening such that the control system can be accessed through the chassis platform from above, e.g., for production and/or maintenance purposes. Each of the chassis platform and the suspended platform may be a plate.

The AGV may further comprise a displacement sensor arranged to sense a displacement of the suspended carrier relative to the chassis. Since the AGV already comprises the suspended carrier that is movable relative to the chassis and that extends horizontally outside of the chassis, no further components in addition to the displacement sensor may have to be added to sense when the suspended carrier contacts an obstacle.

The displacement sensor may be in signal communication with the control system. The displacement sensor may be configured to send a signal indicative of the displacement of the suspended carrier relative to the chassis to the control system.

The displacement sensor may be positioned in the space. The displacement sensor may for example be an optical sensor or a contact sensor. If the displacement sensor is a contact sensor, a first part of the displacement sensor may be fixed to the chassis and a second part of the displacement sensor may be fixed to the suspended carrier, either inside or outside of the suspended barrier.

The AGV may further comprise at least one topographic sensor horizontally within the chassis. The chassis will thereby protect the topographic sensor against mechanical impacts. Each topographic sensor may be positioned entirely horizontally within the chassis. Each topographic sensor may be mounted at a height of less than 20 cm from the horizontal surface. Each topographic sensor may be a two-dimensional topographic sensor, e.g., arranged to sense a topography in a horizontal plane, such as a two-dimensional LIDAR (laser imaging, detection, and ranging) sensor. Each topographic sensor may be in signal communication with the control system.

The AGV may comprise four wheel units. In these cases, the wheel units may be positioned at corners of a parallelogram shape.

Each topographic sensor may be positioned horizontally outside a wheel unit at a corner of the parallelogram shape having an obtuse angle. This enables larger topographic sensors to be used while still being positioned horizontally within the chassis. In these variants, the at least one topographic sensor may comprise two topographic sensors, each positioned horizontally outside a wheel unit at a corner of the parallelogram shape having an obtuse angle

A portion of the suspended carrier extending horizontally outside of the chassis may comprise an external damping structure. The external damping structure provides additional damping (in addition to the damping by the relative movements between the suspended carrier and the chassis) should the suspended carrier collide with an obstacle.

The external damping structure may for example comprise, or be constituted by, a material having a Young's modulus of less than 1 GPa, such as less than 0.5 GPa. One example of such material is rubber. The external damping structure may be a padding and/or a list enclosing the AGV. In any case, the external damping structure may be less rigid than a suspended platform of the suspended carrier, internal of the external damping structure.

Each suspension element may comprise a spring.

Each suspension element may comprise an elongated member connected to the suspended carrier. In these cases, the spring may be arranged between the chassis and the elongated member. Moreover, in these cases, the spring may provide a flexible joint allowing each elongated member to rotate relative to the chassis against the resiliency of the spring. Each spring may thereby function as a ball joint enabling the suspended carrier to move horizontally relative to the chassis in any direction. At the same time, the one or more springs provide vibration isolation for the suspended carrier with respect to vibrations occurring in the chassis. The spring may for example be made of rubber or another material having a Young's modulus of less than 1 GPa, such as less than 0.5 GPa.

Each elongated member may be either stiff or flexible. Each elongated member may for example comprise a rigid bar, e.g., made of plastic or metal. In such variants, frequencies of disturbances acting on the elongated member can be accurately calculated, e.g., by the control system. In alternative variants, each elongated member may be flexible, such as comprising a rope, chain or wire.

The wheel units and the suspension elements may be alternatingly arranged along a path substantially conforming to an exterior profile of the chassis. This contributes to a compact design of the AGV.

The suspended carrier may extend horizontally outside of the chassis on all sides of the same, or it may horizontally enclose the chassis.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An automated guided vehicle (AGV), comprising:
a chassis;
a plurality of wheel units connected to the chassis, each of the plurality of wheel units comprising a wheel for supporting the chassis on a horizontal surface;
an electronic control system in signal communication with the plurality of wheel units; and
one or more resilient suspension elements;
wherein the AGV further comprises a suspended carrier suspended from the chassis via the one or more resilient suspension elements, the suspended carrier carrying the control system horizontally inside of the chassis and extending horizontally outside of the chassis.

2. The AGV of claim 1, further comprising a space horizontally inside of the chassis and defined horizontally between the chassis and the suspended carrier.

3. The AGV of claim 2, wherein the space is a channel enclosing the plurality of wheel units.

4. The AGV of claim 2, wherein the chassis comprises a chassis platform and a chassis barrier extending downwardly from the chassis platform, wherein the suspended carrier comprises a suspended platform and a suspended barrier extending upwardly from the suspended platform, and wherein the space is defined between the chassis barrier and the suspended barrier.

5. The AGV of claim 1, further comprising a displacement sensor arranged to sense a displacement of the suspended carrier relative to the chassis.

6. The AGV of claim 5, further comprising a space horizontally inside of the chassis and defined horizontally between the chassis and the suspended carrier, wherein the displacement sensor is positioned in the space.

7. The AGV of claim 1, further comprising at least one topographic sensor horizontally within the chassis.

8. The AGV of claim 1, wherein the plurality of wheel units is four wheel units.

9. The AGV of claim 8, wherein the four wheel units are positioned at corners of a parallelogram shape.

10. The AGV of claim 7, wherein the at least one topographic sensor is positioned horizontally outside one of the plurality of wheel units at a corner of a parallelogram shape having an obtuse angle.

11. The AGV of claim 1, wherein a portion of the suspended carrier extending horizontally outside of the chassis comprises an external damping structure.

12. The AGV of claim 1, wherein each suspension element comprises a spring.

13. The AGV of claim 12, wherein each suspension element comprises an elongated member connected to the suspended carrier, and wherein the spring is arranged between the chassis and the elongated member.

14. The AGV of claim 1, wherein the wheel units and the suspension elements are alternatingly arranged along a path substantially conforming to an exterior profile of the chassis.

15. The of claim 1, wherein the suspended carrier horizontally encloses the chassis.
